(19) United States
(12) Patent Application Publication
(10) Pub. No.: US 2012/0057832 A1
(43) Pub. Date: Mar. 8, 2012

(54) INTEGRATED OPTICAL FIBER CONNECTOR COMPONENT

(75) Inventors: Tsung-Ting SUN, New Taipei City (TW); Chung-Ping Feng, New Taipei City (TW); Cheng-Chieh HSU, New Taipei City (TW)

(73) Assignee: EDISON OPTO CORPORATION

(21) Appl. No.: 13/221,839

(22) Filed: Aug. 30, 2011

(30) Foreign Application Priority Data
Sep. 3, 2010 (TW) 099129798

(51) Int. Cl. G02B 6/36

(52) U.S. Cl. 385/88

(57) ABSTRACT

An integrated optical fiber connector component includes a light transmitting-side circuit unit, a signal input pin, a light emitting unit, a light receiving-side circuit unit, a signal output pin, a light detecting unit, an integrated positive power pin, and an integrated negative power pin. The integrated positive power pin and the integrated negative power pin are electrically connected to the light transmitting-side circuit unit and the light receiving-side circuit unit. The light transmitting-side circuit unit, the light receiving-side circuit unit and the light detecting unit are integrated in an integrated circuit (IC). The light transmitting-side circuit unit, the light receiving-side circuit unit, the light emitting unit, and the light detecting unit are assembled in a package. The integrated optical fiber connector component of the present invention has reduced space when it is installed on a notebook computer, and has reduced manufacturing complexity and cost.

### BACKGROUND OF THE INVENTION

1. Field of the Invention

The present invention relates to an optical fiber connector component, in particular to an integrated optical fiber connector component.

2. Description of Prior Art

Optical communication, such as optical fiber communication, is a very popular technical subject in the modern times. Optical fiber communication includes a lot of advantages, such as large transmission capacity, low loss and good reliability, etc. Generally, optical fiber communication can briefly divide into three parts: light transmitting side, optical fiber, and light receiving side. The following description will briefly describe the optical fiber connector components of the light transmitting side and the light receiving side.

FIG. 2 shows a block diagram of light transmitting-side optical fiber connector component in the prior art. The light transmitting-side optical fiber connector component 20 in prior art includes a light transmitting-side circuit unit 202, which comprises a light transmitting side amplifier 212, a light emitting unit 204, a signal input pin 206, a light transmitting-side positive power pin 208, and a light transmitting-side negative power pin 210. The light transmitting-side circuit unit 202 includes a light transmitting-side amplifier 212. The said light transmitting-side circuit unit 202 is arranged in an integrated circuit (IC) and electrically connected to the light emitting unit 204, the signal input pin 206, the light transmitting-side positive power pin 208, and the light transmitting-side negative power pin 210.

The light transmitting-side circuit unit 202 receives power through the light transmitting-side positive power pin 208 and the light transmitting-side negative power pin 210. Electrical signals are inputted through the signal input pin 206 to the light transmitting-side circuit unit 202 to control the light emitting unit 204 to emit light signals, thus completing the process of transforming electrical signals into light signals. Therefore, the said process is performed that the electric signals convert to the optical signals.

FIG. 3 shows a block diagram of light receiving-side optical fiber connector component in the prior art. A light receiving-side optical fiber connector component 30 in the prior art includes a light receiving-side circuit unit 302, a light detecting unit 304, a signal output pin 306, a light receiving-side positive power pin 308, and a light receiving-side negative power pin 310. The light receiving-side circuit unit 302 includes a light receiving-side amplifier 312 and the light detecting unit 304. The light receiving-side circuit unit 302 is arranged in an integrated circuit (IC) and is electrically connected to the signal output pin 306, the light receiving-side positive power pin 308, and the light receiving-side negative power pin 310.

The light receiving-side circuit unit 302 receives power through the light receiving-side positive power pin 308 and the light receiving-side negative power pin 310. Light signals are detected by the light detecting unit 304 to send to the light receiving-side circuit unit 302 to output electrical signals through the signal output pin 306, thus completing the process of transforming light signals into electrical signals.

According to above description, the present situations of the light transmitting-side optical fiber connector component 20 in the prior art and the light receiving-side optical fiber connector component 30 in the prior art are as following:

1. The light transmitting-side circuit unit 202 of the light transmitting-side optical fiber connector component 20 in the prior art receives power through the light transmitting-side positive power pin 208 and the light transmitting-side negative power pin 210. The light receiving-side circuit unit 302 receives power through the light receiving-side positive power pin 308 and the light receiving-side negative power pin 310. It means that the light transmitting-side circuit unit 202 and the light receiving-side circuit unit 302 individually have their own power supply pins, not common power pin.

2. The light transmitting-side optical fiber connector component 20 in the prior art and the light receiving-side optical fiber connector component 30 in the prior art are independent components. Moreover, the light transmitting-side circuit unit 202 of the light transmitting-side optical fiber connector component 20 in the prior art is set in an integrated circuit (IC), and the light receiving-side circuit unit 302 of the light receiving-side optical fiber connector component 30 in the prior art is set in another integrated circuit (IC). It means that there will be two integrated circuits (ICs), one for light transmitting-side and the other for light receiving-side.

3. The light transmitting-side circuit unit 202 and the light emitting unit 204 of the light transmitting-side optical fiber connector component 20 in the prior art are included in a package, and the light receiving-side circuit unit 302 of the light receiving-side optical fiber connector component 30 in the prior art is included in another package. Therefore, there will be two packages, one for light transmitting-side and the other for light receiving-side.

FIG. 4 shows a diagram of installation in notebook for light transmitting-side optical fiber connector component in the prior art and light receiving-side optical fiber connector component in the prior art. As mentioned above, the light transmitting-side optical fiber connector component 20 in the prior art and the light receiving-side optical fiber connector component 30 in the prior art individually have power supply pins, integrated circuit (ICs), and packages, so they will occupy such certain volume inside a notebook and certain area in the lateral face of a notebook which waste the space inside a notebook. Furthermore, it would increase the complexity and the cost for manufacturing both the light transmitting-side optical fiber connector component 20 in the prior art and the light receiving-side optical fiber connector component 30 in the prior art.

### SUMMARY OF THE INVENTION

In order to solve the above-mentioned problems, an object of the present invention is to provide an integrated optical fiber connector component for reducing the installation space inside a notebook, manufacturing complexity and cost.

In order to achieve the object of the present invention mentioned above, the integrated optical fiber connector component of the present invention includes a light transmitting-side circuit unit which includes a light transmitting-side amplifier, a signal input pin electrically connected to the light transmitting-side circuit unit, a light emitting unit electrically connected to the light transmitting-side circuit unit, a light receiving-side circuit unit which includes a light receiving-side amplifier and is electrically connected to the light transmitting-side circuit unit, a signal output pin electrically connected to the light receiving-side circuit unit, a light detecting unit electrically connected to the light receiving-side circuit unit, an integrated positive power pin electrically connected to the light transmitting-side circuit unit and the light receiving-side circuit unit, and an integrated negative power pin electrically connected to the light transmitting-side circuit unit and the light receiving-side circuit unit. The light transmitting-side circuit unit, the light receiving-side circuit unit and the light detecting unit are integrated in an integrated circuit (IC). The light transmitting-side circuit unit, the light receiving-side circuit unit, the light emitting unit, and the light detecting unit are assembled in a package.

### BRIEF DESCRIPTION OF DRAWING

FIG. 1 shows a block diagram of the integrated optical fiber connector component of the present invention.

FIG. 2 shows a block diagram of light transmitting-side optical fiber connector component in the prior art.

FIG. 3 shows a block diagram of light receiving-side optical fiber connector component in the prior art.

FIG. 4 shows a diagram of installation in notebook for light transmitting-side optical fiber connector component in the prior art and light receiving-side optical fiber connector component in the prior art.

FIG. 5 shows a diagram of installation in notebook for the integrated optical fiber connector component of the present invention.

FIG. 6 shows a diagram of a package for the integrated optical fiber connector component of the present invention.

### DETAILED DESCRIPTION OF THE INVENTION

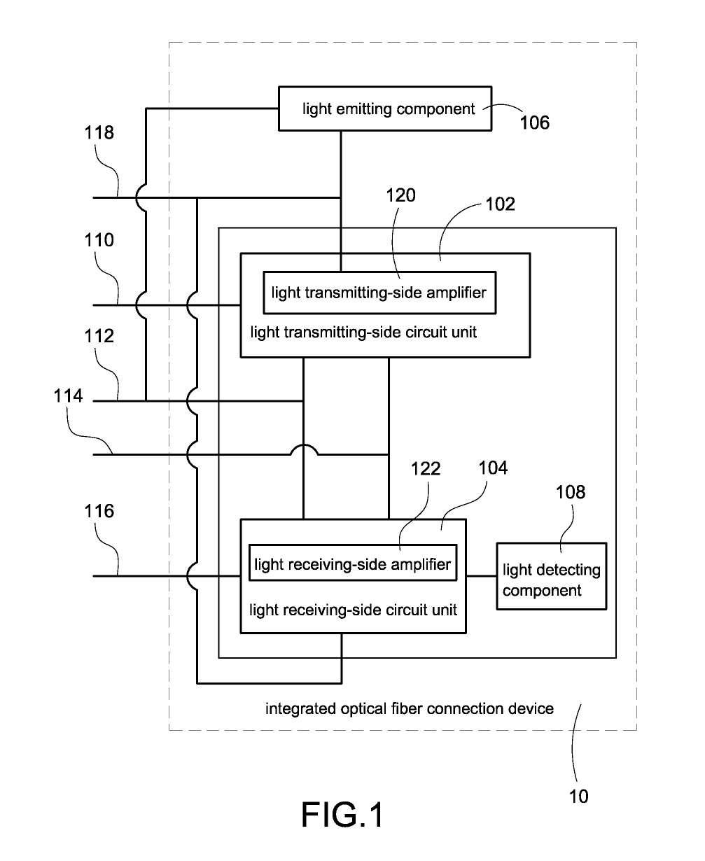

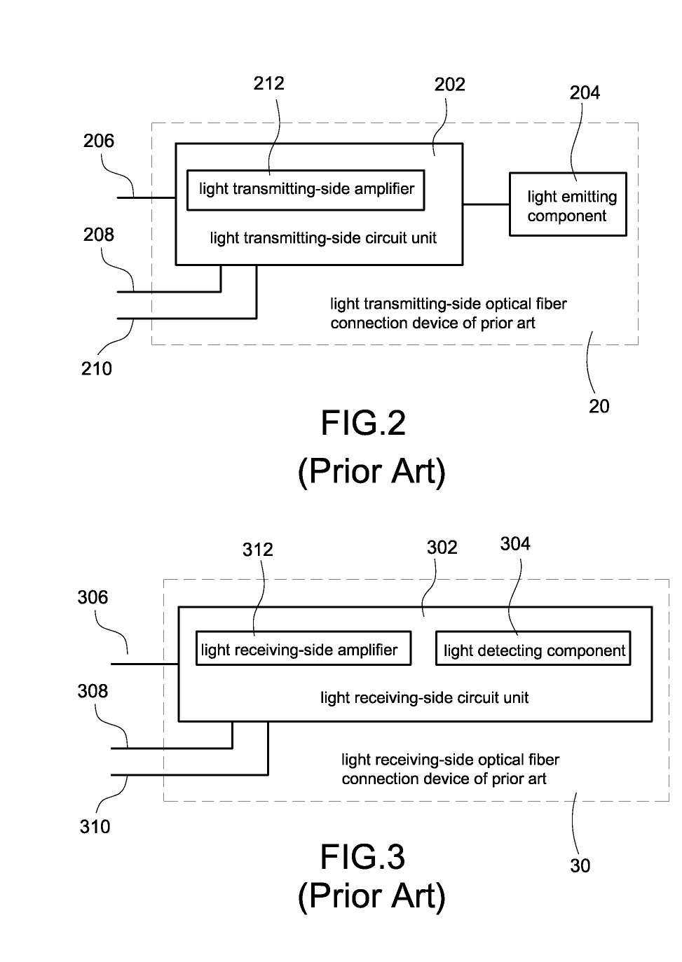

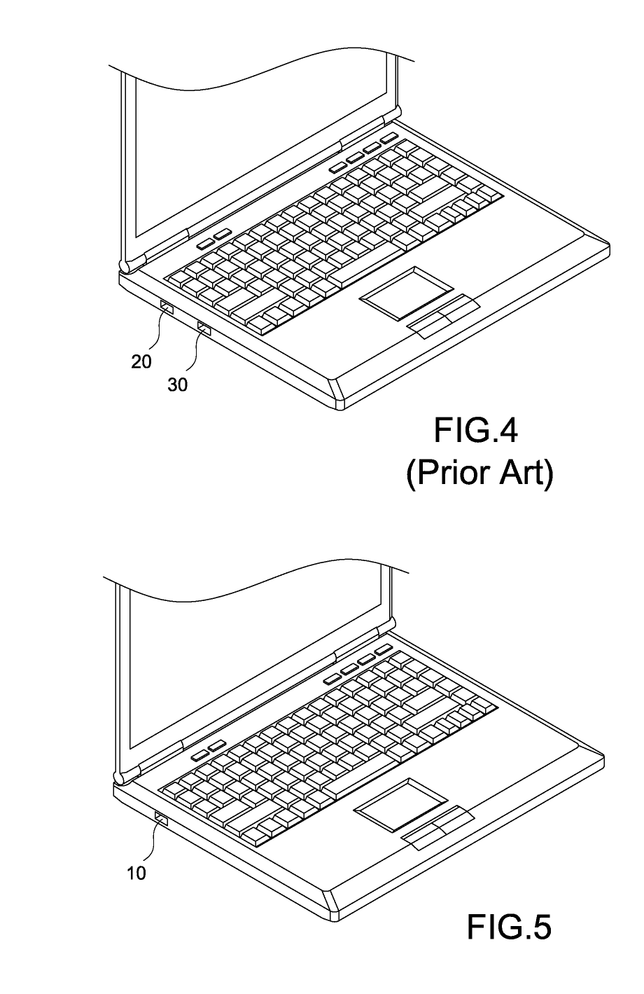

FIG. 1 shows a block diagram of the integrated optical fiber connector component of the present invention. The integrated optical fiber connector component 10 of the present invention includes a light transmitting-side circuit unit 102, a light receiving-side circuit unit 104, a light emitting unit 106, a light detecting unit 108, a signal input pin 110, an integrated positive power pin 112, an integrated negative power pin 114, a signal output pin 116, and a signal control pin 118. The light transmitting-side circuit unit 102 includes a light transmitting-side amplifier 120. The light receiving-side circuit unit 104 includes a light receiving-side amplifier 122.

The light transmitting-side circuit unit 102 is electrically connected to the signal input pin 110, the integrated positive power pin 112, the integrated negative power pin 114, the signal control pin 118, the light receiving-side circuit unit 104, and the light emitting unit 106, wherein the light emitting unit 106 is electrically connected to the positive power pin 112, and the light transmitting-side circuit unit 102 is electrically connected to the signal input pin 110, the integrated positive power pin 112, the integrated negative power pin 114, and the signal control pin 118 with wire bonding structure.

The light receiving-side circuit unit 104 is electrically connected to the signal output pin 116, the integrated positive power pin 112, the integrated negative power pin 114, the signal control pin 118, the light transmitting-side circuit unit 102, and the light detecting unit 108, wherein the light receiving-side circuit unit 104 is electrically connected to the signal output pin 116, the integrated positive power pin 112, the signal control pin 118, and the integrated negative power pin 114 with wire bonding structure.

The light receiving-side amplifier 122 could be a pre-amplifier. The light transmitting-side amplifier 120 could be an operational amplifier. The light emitting unit 106 could be an LED, for example a red light LED or a blue light LED. The light transmitting-side circuit unit 102 and the light receiving-side circuit unit 104 are electrically connected to the integrated positive power pin 112 and the integrated negative power pin 114 with wire bonding structure to share the integrated positive power pin 112 and the integrated negative power pin 114 to receive power.

The integrated optical fiber connector component 10 could be selectively as a light transmitting-side optical fiber connector component or a light receiving-side optical fiber connector component based on detecting the connector inserted in the integrated optical fiber connector component 10 or based on controlling software, etc. The detail thereof is as following:

1. When the integrated optical fiber connector component 10 is used as a light transmitting-side optical fiber connector component, electrical signals are inputted through the signal input pin 110 to the light transmitting-side circuit unit 102 to control the light signals emitted from the light emitting unit 106 electrically connected to the integrated positive power pin 112. The light emitting unit 106 is assembled on the signal control pin 118. In that case, the signal control pin 118 is used to conduct the light emitting unit 106. Moreover, the signal control pin 118 is used to shutdown the light receiving-side circuit unit 104 to avoid signal interference caused from the light signals sending from the light emitting unit 106 to the light detecting unit 108.

2. When the integrated optical fiber connector component 10 is used as a light receiving-side optical fiber connector component, light signals are detected by the light detecting unit 108 to send to the light receiving-side circuit unit 104 to deal to output electrical signals through the signal output pin 116. Moreover, the signal control pin 118 is used to shutdown the light transmitting-side circuit unit 102 to avoid signal interference caused from the light signals sending from the light emitting unit 106 to the light detecting unit 108.

The light transmitting-side circuit unit 102 and the light receiving-side circuit unit 104 of the integrated optical fiber connector component 10 of the present invention are electrically connected to the positive power pin 112 and the negative power pin 114 with wire bonding structure respectively to share the positive power pin 112 and the negative power pin 114 to receive power, so it uses less power pins than prior art device.

Moreover, the light transmitting-side circuit unit 102, the light receiving-side circuit unit 104, and the light detecting unit 108 are integrated in an integrated circuit (IC). The light emitting unit 106 is selectable to assemble on the surface of the integrated circuit (IC) including the light transmitting-side circuit unit 102, the light receiving-side circuit unit 104, and the light detecting unit 108. For example, when the light emitting unit 106 is assembled on the upper surface or by the side of the light detecting unit 108 included in the integrated circuit (IC) (more details will be described afterward), the light transmitting-side circuit unit 102, the light receiving-side circuit unit 104, the light emitting unit 106, the light detecting unit 108, the light transmitting-side amplifier 120, and the light receiving-side amplifier 122 are assembled in a package (more details will be described afterward).

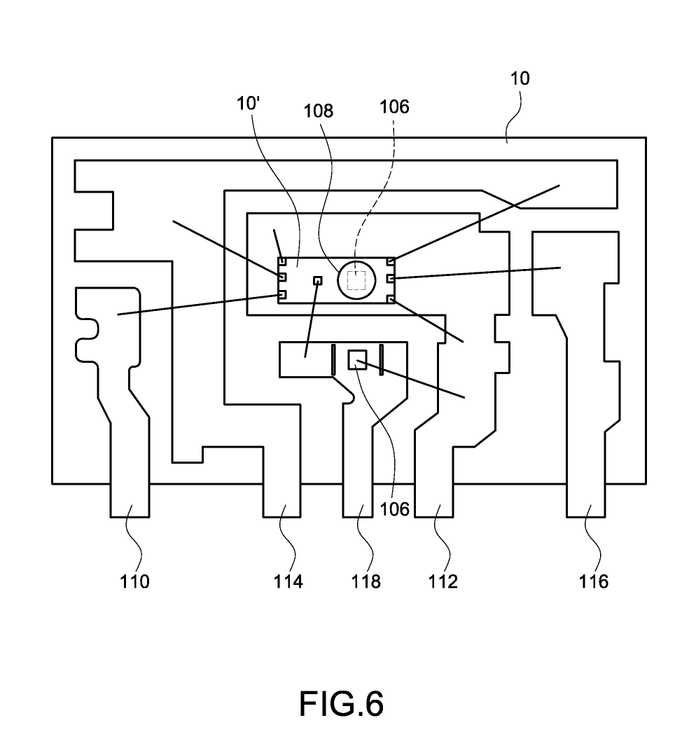

FIG. 6 shows a diagram of a package for the integrated optical fiber connector component of the present invention. As shown in the FIG. 6, the light transmitting-side circuit unit 102, the light receiving-side circuit unit 104, and the light detecting unit 108 are integrated in a chip 10′. In that case, the light emitting unit 106 is selectable to assemble on the surface of the chip 10′. That means the light emitting unit 106 can be selectively to assemble by the side or on the upper surface of the light detecting unit 108 included in the chip 10′, or on the lead frame of the signal control pin 118 outside of the chip 10′. No matter the light emitting unit 106 is assembled on the surface of the chip 10′ or on the signal control pin 118, the light emitting unit 106 is electrically connected to the integrated positive power pin 112 with wire bonding structure to receive power.

As shown in the FIG. 6, when the light emitting unit 106 is assembled on the surface of lead frame of the integrated optical fiber connector component 10 (for example on the lead frame of the signal control pin 118), the light emitting unit 106 is electrically connected to the light transmitting-side circuit unit 102 in the chip 10′ with wire bonding structure, so that the light emitting unit 106 is controlled by the light transmitting-side circuit unit 102. In that case, an optical fiber (not shown in the FIG. 6) transmitting light signals is aligned with the light detecting unit 108. Moreover, the light emitting unit 106 could be assembled by the side or on the upper surface of the light detecting unit 108 (shown as dashed line in the FIG. 6). If the transmission power of the light emitting unit 106 is strong enough, there will be enough light to couple with the optical fiber. In that case, an optical fiber (not shown in the FIG. 6) transmitting light signals also is aligned with the light detecting unit 108 and the light emitting unit 106.

FIG. 5 shows a diagram of installation in notebook for the integrated optical fiber connector component of the present invention. As mentioned above, when the integrated optical fiber connector component of the present invention is applied to a notebook, the light transmitting-side and the light receiving-side share power pins, integrated circuit (IC), and package, so it will occupy less volume inside a notebook and less area in the lateral of a notebook than prior art. This will avoid wasting the space inside the notebook in order to increase the space can be used. Moreover, there are both not necessary to manufacture the light transmitting-side optical fiber connector component 20 in prior art and the light receiving-side optical fiber connector component 30 in prior art individually, but manufacturing only the integrated optical fiber connector component 10 is required, so that the manufacturing complexity and cost is reduced.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An integrated optical fiber connector component including:
a light transmitting-side circuit unit including a light transmitting-side amplifier;
a signal input pin electrically connected to the light transmitting-side circuit unit;
a light emitting unit electrically connected to the light transmitting-side circuit unit;
a light receiving-side circuit unit including a light receiving-side amplifier and electrically connected to the light transmitting-side circuit unit;
a signal output pin electrically connected to the light receiving-side circuit unit;
a light detecting unit electrically connected to the light receiving-side circuit unit;
an integrated positive power pin electrically connected to the light transmitting-side circuit unit and the light receiving-side circuit unit; and
an integrated negative power pin electrically connected to the light transmitting-side circuit unit and the light receiving-side circuit unit,
wherein the light transmitting-side circuit unit, the light receiving-side circuit unit and the light detecting unit are integrated in an integrated circuit (IC), wherein the light transmitting-side circuit unit, the light receiving-side circuit unit, the light detecting unit, and the light emitting unit are assembled in a package.

2. The integrated optical fiber connector component in claim 1, further including a signal control pin electrically connected to the light transmitting-side circuit unit.

3. The integrated optical fiber connector component in claim 1, wherein the light emitting unit is assembled on the upper surface or by the side of the light detecting unit.

4. The integrated optical fiber connector component in claim 2, wherein the light emitting unit is assembled on the surface of signal control pin.

5. The integrated optical fiber connector component in claim 1, wherein the light transmitting-side amplifier is an operational amplifier.

6. The integrated optical fiber connector component in claim 1, wherein the light receiving-side amplifier is a pre-amplifier.

7. The integrated optical fiber connector component in claim 1, wherein the light emitting unit is a light emitting diode (LED).

8. The integrated optical fiber connector component in claim 1, wherein the light transmitting-side circuit unit and the light receiving-side circuit unit share the integrated positive power pin and the integrated negative power pin.
